(19) United States
(12) Patent Application Publication
(10) Pub. No.: US 2025/0376282 A1
(43) Pub. Date: Dec. 11, 2025

(54) EXCHANGEABLE CAP GRIPPER CARTRIDGE FOR CAPPING AND DE-CAPPING OF TEST TUBES

(71) Applicant: LABSOLUZ APS, Karlslunde (DK)

(72) Inventors: Lars Weber HOVENDAHL, Karlslunde (DK); Stig CHRISTENSEN, Karlslunde (DK)

(73) Assignee: LABSOLUZ APS, Karlslunde (DK)

(21) Appl. No.: 18/877,025

(22) PCT Filed: Jun. 20, 2023
(86) PCT No.: PCT/EP2023/066692

§ 371 Date: Dec. 19, 2024

(30) Foreign Application Priority Data
Jun. 20, 2022 (EP) 22180009.7

(51) Int. Cl. B65B 7/28; B67B 7/18; G01N 35/04

(52) U.S. Cl. CPC B65B 7/2835; B67B 7/182; G01N 35/04; G01N 2035/0496

(57) ABSTRACT

A cap gripper cartridge for releasably connecting to a head unit of a test tube capper-decapper device is herein disclosed, the cap gripper cartridge comprising a cap gripper holder rotatably bearing a plurality of cap grippers arranged in a 2-dimensional array; and a cap ejector plate comprising a plurality of throughbores respectively arranged around a respective cap gripper of the plurality of cap grippers between the cap gripper holder and a respective cap socket comprised in a respective cap gripper; the cap ejector plate arranged for being displaced relative away from the cap gripper holder for engaging at least one test tube cap retained by the respective cap socket, and effecting a release of the at least one test tube cap by the displacement.

### TECHNICAL FIELD

The present invention relates to an exchangeable cap gripper cartridge for capping and de-capping of test tubes, a capper-decapper device comprising a cartridge, and methods of capping and de-capping test tubes.

### BACKGROUND

In recent years automated capping and de-capping of test tubes has become an important field of technology given the increasing use of standardized size and formats of test tubes for use e.g., in biology and microbiology. In these fields, often very large numbers of test tubes must be de-capped and capped for sample examination, e.g., for mass testing during the COVID-19 pandemic, under conditions where human intervention must be kept at a minimum during automated sample handling for diagnostic safety and reliability, but also for reasons of efficacy and testing speed. However, also for reasons of ergonomic safety at the workplace, human capper-decapper operations should be minimized, as the repeated capping and de-capping operation, in particular where this operation involves a rotational movement for screwing and unscrewing threaded test tube caps, can, when repeated often, lead to tendonitis in the persons performing the capping and de-capping of such threaded test tube caps. Hence, automation has become a necessity.

A particular important step towards increasing the use of automated capper-decapper devices has been the introduction of standardization within the field of test tubes and within the field of standardized racks for holding standardized test tubes. Today, the dominating standard for racks for biological and microbiological test tubes are the so-called SBS format racks in accordance with ANSI standard ANSI SLAS x-2004, wherein x=1, 2, . . . 6. Such SBS racks may contain, for example 96 test tubes in an array of 8 by 12 apertures designed to hold the tubes securely, but also arrays of 4×6, 8×6 are in common use. The advantage for automation is that the test tube positions are predetermined by the standard and automation equipment can rely on these predetermined positions within manufacturing tolerance.

Test tubes suitable for being stored on SBS format racks are numerous, and particular problems arise for each test tube type and associated cap, when considering automated capping and de-capping operations. In the art, screw cap type and click-on cap type test tubes are predominant. The present invention relates to the field of automated capping and de-capping of screw cap type test tubes for storing on a standardized test tube rack, such as e.g., an SBS format test tube rack.

Within the field of capping and de-capping test tubes, particularly screw cap test tubes, a problem repeatedly encountered is that existing test tube capper-decapper devices, such as e.g., the screw cap test tube capper-decapper device detailed in WO 2014023683, are not versatile with respect to the number of test tubes that the capping and de-capping devices of the prior art can handle. Rather, these are locked to a predetermined rack format defined by the number of apertures, such as e.g., 8×12, of a particular test tube rack; to which the test tube capping and de-capping devices of the prior art presents an equal number (here 8×12) of test tube cap grippers for performing capping and de-capping on test tubes arranged in the apertures of the predetermined rack format.

In FIG. 1, the prior art test tube capper-decapper device disclosed in WO 2014023683 is shown. In accordance with this prior art, a capper-decapper device can comprise a fixed bottom plate holding a SBS-rack containing screw cap test tubes, and where, in the device, a spindle-mechanism moves a cap gripper holder comprising a two-dimensional array of individually actuated cap grippers respectively towards or away from test tubes contained in an SBS-rack respectively for capping or de-capping of the test tubes, while a plurality of respective individual rotors contained in the head unit, respectively rotate the respective cap drivers, each containing a cap gripper, either with or against a screw cap closing or opening direction. A particular feature of this device of the prior art is that after capping, a screw cap is ejected from a respective cap gripper by a respective ejector pin slidingly arranged co-axially within each respective cap gripper and ejecting the screw cap when activated by relevant control logic, by exerting a force only on the screw cap, but not on the cap socket.

A versatility problem of this prior art device has been found to be the time needed for individually exchanging cap sockets on cap drivers for switching between different test tube caps and further, that the ejector pins' construction may over time lead to rupture of the screw caps they engage.

In the context of the present invention, elements of the prior art are suitable for the present discussion and have been indicated as numbered elements in FIG. 1 in accordance with the annotation used in the present disclosure, including screw cap test tube capper-decapper device (1), head unit (2), cap driver (4), test tube (5), screw cap (51), spindle-mechanism (28), cap gripper holder (31), and control logics (27).

Due to the restrictions on constructions given by the SBS-standard for which the present invention is primarily adapted, the relative positions of these construction elements indicated in FIG. 1 and within the present invention are similar or identical and guidance for the present application can be derived therefrom if not otherwise specified herein.

The present screw cap test tube capper-decapper device (1) comprises a drive system (28) for moving a cap gripper holder (31) respectively towards or away from test tubes held in a suitable test tube rack respectively during capping or de-capping of the test tubes, where in preferred embodiments, the drive system (28) comprises a spindle-mechanism (28) for moving the cap gripper holder (31) respectively towards or away from a test tube (5) respectively during capping or de-capping of the test tube (5).

Also, a plurality of respective individual rotors in the form of actuation units (6) are arranged in the head unit (2) in a 2-dimensional array, respectively for rotating respective cap drivers either with or against a screw cap closing or opening direction. However, and contrary to the prior art, due to the use of a cap gripper cartridge (3) comprising an ejector plate, further differences exist between the head unit (2) of the present screw cap test tube capper-decapper device (1) compared to the prior art. In particular, when the cap gripper cartridge (3) comprises a transmission system (7), the number of actuator units (6) in the devices (1) of the present disclosure can be smaller than the number of cap grippers (4) comprised in the cap gripper cartridge (3).

In U.S. Pat. No. 9,199,755 there is proposed exchangeable cap gripper cartridges, which were used in WO 2018142361 for obtaining solutions to the problem of switching-time lack-of-versatility, which was sought alleviated by the introduction of an exchangeable cartridge comprising an array of capping and de-capping grippers, each gripper comprising a cap socket for engaging a screw cap on a tube in a test tube rack, with ejection of the respective screw caps after capping and de-capping operation however being caused by respective ejector pins arranged in the capper-decapper head.

The present disclosure is directed to providing inventive solutions to the general problem of increasing the versatility of test tube capper-decapper devices of the prior art, for allowing the test tube capper-decapper devices according to the present disclosure to be useable for capping and de-capping of test tubes stored on a larger variety of test tube racks, than merely one, single, pre-set test tube rack. While generally applicable across the technical field of capping and de-capping of test tubes, nevertheless, in the present invention, dimensions are particularly and preferably in accordance with SBS-type test tube rack standards.

The present disclosure discusses the inventive solutions to the abovementioned general problem in the context of SBS format test tube racks, but the skilled person will realize that the teaching of the present disclosure is not limited thereto, as will be discussed herein below in more detail.

### SUMMARY OF THE INVENTION

In accordance with the present invention there is herein disclosed: A cap gripper cartridge (3) for releasably connecting to a head unit (2) of a screw cap test tube capper-decapper device (1) and having a common axis of engagement (22) after connecting, the cap gripper cartridge (3) comprising:
a cap gripper holder (31) defining a head unit side (311) and a test tube side (312) and rotatably bearing a plurality of cap grippers (4) arranged in a two-dimensional array (313), the common axis of engagement (22) being perpendicular to the two-dimensional array (313), wherein
   a respective cap gripper (4) comprises a respective cap socket (41) arranged for engaging and retaining a test tube screw cap (51) during and after a capping or a de-capping of the test tube screw cap (51) to or from a screw cap test tube (5),
   a respective cap socket (41) is connected by a respective cap gripper axle (42) arranged in parallel to the common axis of engagement (22), to a respective head unit connector (43), the respective head unit connector (43) arranged for connecting to the head unit (2), and transferring after connection a rotation received from the head unit (2) to a rotation of the respective cap socket (41), and wherein
   each respective cap socket (41) presents to the test tube side (312), and each respective head unit connector (43) presents to the head unit side (311);
      the cap gripper cartridge (3) further comprising:
a cap ejector plate (32) comprising a plurality of respective throughbores (321), a respective throughbore (321) arranged around a respective cap gripper axle (42) of a respective cap gripper (4) comprised in the two-dimensional array (313), between the
cap gripper holder (31) and the respective cap socket (41); and
at least one actuable cap ejector plate displacer (33);
wherein
the cap ejector plate (32) is arranged for being displaced by the actuable cap ejector plate displacer (33) along the common axis of engagement (22) relative away from the cap gripper holder (31) for engaging all respective test tube screw caps (51) retained in all respective cap sockets (41) comprised in all respective cap grippers (4) held by the cap gripper cartridge (3), and effecting by the displacement a release of the all retained test tube screw caps (51) from all respective cap sockets (41) holding a screw cap.

By integrating ejection means, here in the form a cap ejector plate (32), into the cap gripper cartridge (3) improvements to capping and de-capping operations of screw cap test tubes (5) are obtained when it is desired to cap or de-cap all test tubes held in a two-dimensional array in one step, while alleviating prior art problems of ejector pin caused damage to the screw caps being ejected from a cap gripper cartridge of the prior art.

### BRIEF DESCRIPTION OF THE DRAWINGS

FIG. 1: A prior art capper-decapper device.

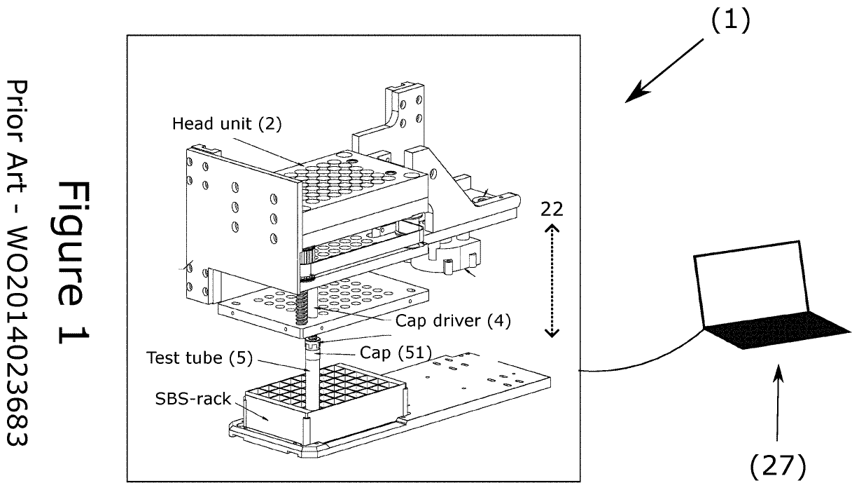

FIG. 2A: An exchangeable cap gripper cartridge-cap gripper holder.

FIG. 2B: An exchangeable cap gripper cartridge-cap ejector plate.

FIG. 3: Cross-section of an exchangeable cap gripper cartridge.

FIG. 4: An actuator unit and a cap gripper.

FIG. 5A: A head unit for a capper-decapper device.

FIG. 5B: A head unit with a cap gripper cartridge loaded.

FIG. 6: Transmission system on cap gripper holder.

FIG. 7: Transmission system on cap gripper holder.

FIG. 8: Transmission system on cap gripper holder

It is to be understood, that the embodiments shown in the figures are for illustration of the present invention and cannot be construed as being limiting on the present invention. Unless otherwise indicated, the drawings are intended to be read (e.g., cross-hatching, arrangement of parts, proportion, degree, etc.) together with the specification, and are to be considered a portion of the entire written description of this disclosure.

### DETAILED DESCRIPTION

In accordance with the present disclosure, a cap gripper cartridge (3) for releasably connecting to a head unit (2) of a test tube capper-decapper device (1) is herein disclosed, the cap gripper cartridge (3) comprising a cap gripper holder (31) rotatably bearing a plurality of cap grippers (4) arranged in a two-dimensional array (313); and a cap ejector plate (32) comprising a plurality of throughbores (321) respectively arranged around a respective cap gripper of the plurality of cap grippers (4) between the cap gripper holder (31) and a respective cap socket (41) comprised in a respective cap gripper (4); the cap ejector plate (32) arranged for being displaced relative away from the cap gripper holder (31) for engaging at least one test tube cap retained by the respective cap socket (41), and effecting a release of the at least one test tube cap by the displacement.

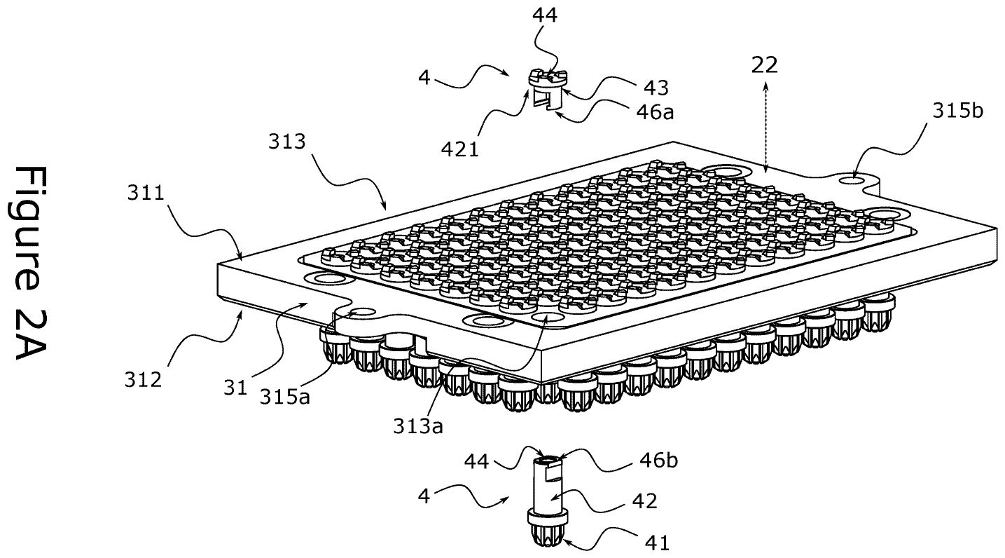

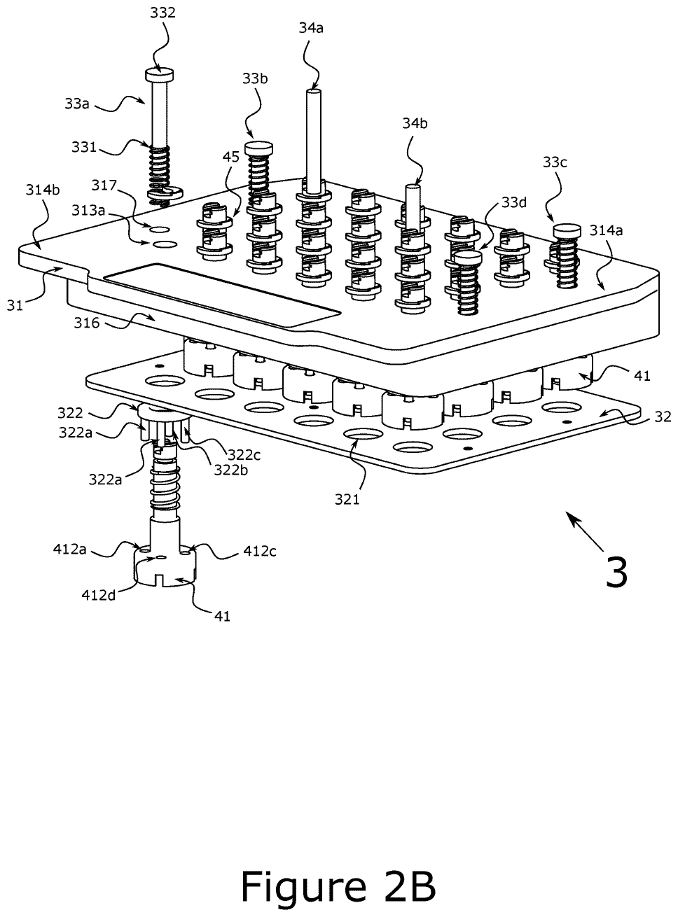

In accordance therewith (c.f. FIGS. 2A and 2B), there is herein disclosed a cap gripper cartridge (3) for releasably connecting to a head unit (2) of a screw cap test tube capper-decapper device (1), the cap gripper cartridge (3) comprising:
a cap gripper holder (31) defining a head unit side (311) and a test tube side (312), and rotatably bearing a plurality of cap grippers (4) arranged in a two-dimensional array (313); a respective cap gripper (4) comprising a cap socket (41) arranged for engaging and holding a test tube screw cap (51) during and after a capping or a de-capping of the test tube screw cap (51) to or from a screw cap test tube (5), and connected by a cap gripper axle (42) to a head unit connector (43) arranged for connecting to, and transferring a rotation after connection received from, the head unit (2) to a rotation of the cap socket (41); each respective cap socket (41) presenting to the test tube side (312), and each respective head unit connector (43) presenting to the head unit side (311); and
a cap ejector plate (32) comprising a plurality of throughbores (321), a respective throughbore (321) arranged around a respective cap gripper axle (42) between the cap gripper holder (31) and a respective cap socket (41); the cap ejector plate (32) arranged for being displaced along a the respective cap gripper axle (42) relative away from the cap gripper holder (31) for engaging at least one test tube screw cap (51) retained by a respective cap socket (41) comprised in a respective cap gripper (4), and effecting a release of the at least one test tube screw cap (51) from the cap socket (41) by the displacement.

In accordance therewith (c.f. FIGS. 2A and 2B), there is herein disclosed a cap gripper cartridge (3) for releasably connecting to a head unit (2) of a screw cap test tube capper-decapper device (1) and having a common axis of engagement (22) after connecting, the cap gripper cartridge (3) comprising:
a cap gripper holder (31) defining a head unit side (311) and a test tube side (312) and rotatably bearing a plurality of cap grippers (4) arranged in a two-dimensional array (313), the common axis of engagement (22) being perpendicular to the two-dimensional array (313), wherein
   a respective cap gripper (4) comprises a respective cap socket (41) arranged for engaging and retaining a test tube screw cap (51) during and after a capping or a de-capping of the test tube screw cap (51) to or from a screw cap test tube (5),
   a respective cap socket (41) is connected by a respective cap gripper axle (42) arranged in parallel to the common axis of engagement (22), to a respective head unit connector (43), the respective head unit connector (43) arranged for connecting to the head unit (2), and transferring after connection a rotation received from the head unit (2) to a rotation of the respective cap socket (41), and wherein
   each respective cap socket (41) presents to the test tube side (312), and each respective head unit connector (43) presents to the head unit side (311);
the cap gripper cartridge (3) further comprising:
a cap ejector plate (32) comprising a plurality of respective throughbores (321), a respective throughbore (321) arranged around a respective cap gripper axle (42) of a respective cap gripper (4) comprised in the two-dimensional array (313), between the cap gripper holder (31) and the respective cap socket (41); and
at least one actuable cap ejector plate displacer (33);
wherein
the cap ejector plate (32) is arranged for being displaced by the actuable cap ejector plate displacer (33) along the common axis of engagement (22) relative away from the cap gripper holder (31) for engaging all respective test tube screw caps (51) retained in all respective cap sockets (41) comprised in all respective cap grippers (4) held by the cap gripper cartridge (3), and effecting by the displacement a release of the all retained test tube screw caps (51) from all respective cap sockets (41) holding a screw cap.

The present invention is based on the realization by the present inventors, that since test tube screw caps exhibit free surfaces directed towards a head unit (2) of a screw-cap test tube capper-decapper device (1) along the perimeter of the screw caps, engaging the screw caps at this perimeter allows for a simplified construction of the head unit (2), which no longer is required to hold individually actuated ejector pins and cap drivers, but rather the cap gripper cartridges (3) can hold the ejection means, herein in the form of a ejector plate.

While this reduces the ability to customize the ejection operation in favor of a simultaneous ejection of screw caps that are attached to a cap gripper, other advantages, including larger versatility and reduced damage to screw caps, result from the present invention.

Additionally, in the preferred embodiment detailed herein, wherein the cap gripper cartridges (3) of the present disclosure comprise a transmission system (7), a higher number of differently sized test tube racks can be used with the capper-decapper devices of the present disclosure compared to the capper-decapper devices of the prior art, which were limited to one specific rack for each device.

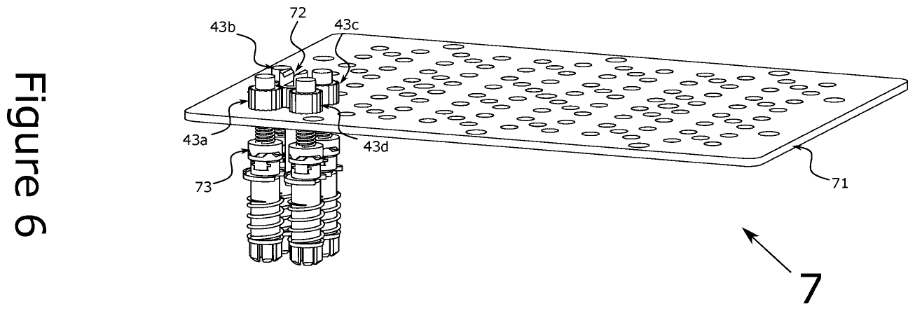

As detailed herein (c.f. FIGS. 6-8), this ultimately allows to dispense with current individually actuated cap drivers in favor of one or only a small number of actuators for performing a screw cap capping and de-capping operation, since in the present system the cap gripper cartridge (3) can be adapted to comprise a transmission system (7) for permitting a single or a small number of actuators (6) comprised in the head unit (2) of the capping and de-capping device (1) to rotate all of the cap grippers (4) comprised in the cap gripper cartridges of the present invention, or if more than one actuator (6) is present in the head unit (2), a limited number of cap gripper clusters, rather than each cap gripper individually.

The particular advantage of this transmission system (7) is, that the head unit (2) may now actuate a screw cap capping or de-capping operation without regards to a predetermined two-dimensional array given by the SBS-format, as the array is now determined by the cap gripper cartridge transmission system rather than the number of actuators comprised in the head unit. It further allows compatibility between a head unit (2) designed e.g., for one standard rack format to cap and de-cap other rack formats, since now the entire rack format information is contained in the cartridge rather than in the head unit of the capper-decapper device.

In some embodiments of the invention, cap gripper cartridges (3) of the invention have a transmission system (7) adapted to the utilize some actuators (6) in the head unit (2), but not all actuators (6) in the head unit (2). This system is suitable for backwards compatibility to capper-decapper devices already on the market, which were designed e.g., for 8×12 test tube racks, but with a cartridge (3) of the present invention, now may also be used for e.g., 4×6 test tube racks. But, going forward, the ability to construct the head unit (2) with a lower number of actuators (6) and use the cartridges (3) of the present invention for compatibility with higher test tube numbers provides significant simplification to the manufacture of the head unit (2) of the capper-decapper devices of the present invention.

Accordingly, in a preferred embodiment, the cap gripper cartridge (3) of the present invention comprises a transmission system (7) for allowing a number of actuators comprised in the head unit (2), the number of actuators being different from, but preferably smaller than, the number of cap grippers (4) comprised in the two-dimensional array (313), to actuate a capping or a de-capping operation of all cap grippers (4) comprised in the two-dimensional array (313) of the cap gripper cartridge (3).

In FIGS. 2A and 2B showing the cap gripper holder (31), a simple construction for rotatably bearing the aforementioned plurality of cap grippers (4) arranged in the aforementioned two-dimensional array (313) on the cap gripper holder (31), wherein the cap gripper holder (31) comprises a first set of throughbores (313a) matching in number and position the aforementioned two-dimensional array (313). A respective cap gripper (4) can then be borne by the cap gripper holder (31) either by presenting a bearing surface (421) towards the head unit side (311) of the cap gripper holder (31) (FIG. 2A) and/or a respective cap gripper (4) may be mounted on the cap gripper holder (31) using a clamp (45) used as bearing and presenting a bearing surface (421) towards the head unit side (311) of the cap gripper holder (31), c.f. in this FIG. 2B and FIG. 6 in connection with the aforementioned preferred transmission system (7).

In accordance with all embodiments of the present invention (c.f. FIG. 2A), there is disclosed a cap gripper cartridge (3), comprising cap gripper holder (31) defining a head unit side (311) and a test tube side (312), and rotatably bearing a plurality of cap grippers (4) arranged in a two-dimensional array (313); a respective cap gripper (4) comprising a cap socket (41) arranged for engaging and holding a test tube screw cap (51) during and after a capping or a de-capping of the test tube screw cap (51) to or from a screw cap test tube (5), and connected by a cap gripper axle (42) to a head unit connector (43) arranged for connecting to, and transferring a rotation after connection received from, the head unit (2) to a rotation of the cap socket (41); each respective cap socket (41) presenting to the test tube side (312), and each respective head unit connector (43) presenting to the head unit side (311).

In the embodiment shown in FIG. 2A, a respective cap gripper (4) is assembled in the cap gripper holder (31) in the two-dimensional array (313) by connecting the cap socket (41) to the head unit (43) using a click-lock arrangement (46a,46b) held, in this example, on the cap gripper axle (42) and the head unit connector (43). But generally, and for the purpose of the present disclosure, it is considered within the abilities of the skilled person to rotably assemble two parts connected by an axle in a bearing.

In accordance with all embodiments of the present invention (c.f. FIG. 2B), the disclosed a cap gripper cartridge (3), further comprises a cap ejector plate (32) comprising a plurality of throughbores (321), a respective throughbore (321) arranged around a respective cap gripper axle (42) between the cap gripper holder (31) and a respective cap socket (41); the cap ejector plate (32) arranged for being displaced along a the respective cap gripper axle (42) relative away from the cap gripper holder (31) for engaging at least one test tube screw cap (51) retained by a respective cap socket (41) comprised in a respective cap gripper (4), and effecting a release of the at least one test tube screw cap (51) from the cap socket (41) by the displacement.

In an embodiment in accordance with all embodiments of the present invention (c.f. FIG. 2B), there is disclosed a cap gripper cartridge (3), wherein at least one actuatable ejector plate displacer (33) engages the cap ejector plate (32) for displacing the cap ejector plate (32) relative away from the cap gripper holder (31) when actuated.

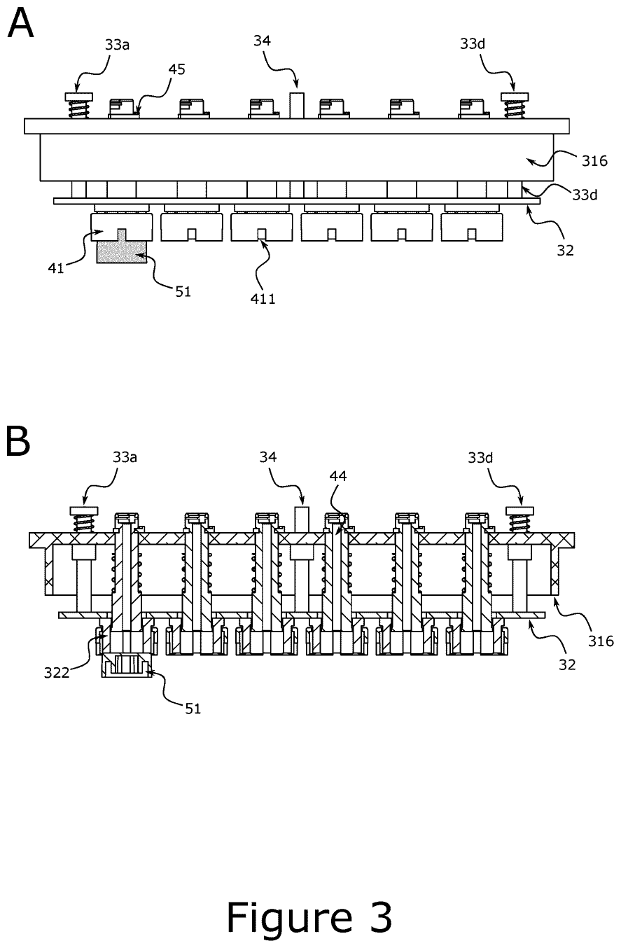

In an embodiment thereof, there is disclosed a cap gripper cartridge (3), further comprising at least two, at least three, but preferably at least four, actuatable ejector plate displacers (33a-d). In FIGS. 2-3 an embodiment is shown, wherein the actuatable ejector plate displacers (33a-d) are in the form of respective ejector pistons individually acting on a respective surface part of the ejector plate (32). This is a preferred embodiment as the embodiment requires a minimal amount of space reserved in the head unit (2) for ejection actuation, however, the present inventors consider it within the abilities of the skilled person to device other positions or arrangements of the at least one actuatable ejector plate displacer (33) based on his common general knowledge.

In an embodiment thereof, there is disclosed a cap gripper cartridge (3), wherein the at least one actuatable ejector plate displacer (33) comprises biasing means (331) for restricting the displacement of the cap ejector plate (32) to a displacement between a first position not engaging a respective test tube screw cap (51) retained by a respective cap socket (41) and a second position ejecting the respective test tube screw cap (51) from the respective cap socket (41).

Whilst it is possible to have the cap ejector plate (32) extend outside at least one side of cap gripper holder (31) and have the at least one ejector plate displacer (33) act on the cap ejector plate (32) at free positions uninfluenced by the cap gripper holder (31), such an embodiment unfortunately can lead to wobbling of the cap ejector plate (32) during cap ejection, and it is therefore preferable to enlarge the cap gripper holder (31) for comprising a second set of respective throughbores (317) for enclosing a respective ejector plate displacer (33) and permitting a respective ejector plate displacer (33a-d) of the at least one ejector plate displacer (33) to move slidingly within a respective throughbore (317a-d) (c.f. FIG. 2B) of the second set of respective throughbores (317)

As can be seen from FIGS. 2 and 3, it is not necessary that the ejector plate (32) of the present invention is carried by the cap gripper holder (31), it can rest on the plurality of cap sockets (41) during capping and de-capping operations and only be actuated to engage the one or more screw caps (51) attached to one or more of the plurality of cap sockets (41) without retracting after contact and ejection. A later renewed attachment of a screw cap will then push the ejector plate (32) back into a ready position for the ejector plate. In the preferred embodiments of the present invention, however, the at least one actuatable ejector plate displacer (33) is attached to the ejector plate (32) and is carried by the cap gripper holder (31).

In the embodiments shown in FIGS. 2 and 3, the at least one actuatable ejector plate displacer (33), in the form of an ejector piston (33) is carried by the cap gripper holder (31) by the action of the biasing means (331) on an ejector piston head (332) arranged at an end of the ejector piston (33) presenting to the head unit side (311). In the embodiment shown, the biasing means (331), as is preferred, is a coil spring arranged around the ejector piston (33), between the ejector piston head (332) and the cap gripper holder (31) on the head unit side (311). This preferred arrangement allows the at least actuatable ejector plate displacer (33), here in the form of at least one ejector piston (33) to reversibly displace between a first position not engaging a respective test tube screw cap (51) retained by a respective cap socket (41) and a second position ejecting the respective test tube screw cap (51) from the respective cap socket (41).

In FIG. 2B and FIGS. 3A and 3B, the embodiments detailed also display one or two ejection steer pins (34,34a,34b), which are fixed to the ejection plate (32) and slidingly traverses the cap gripper holder (31) in a respective throughbore. Thereby wobbling induced by the action of the ejector plate displacers (33a-d) on the ejector plate (32) is minimized and operation stability improved. Accordingly, in an embodiment of the cap gripper cartridge (3) of the present disclosure, the ejection plate (32) comprises at least one affixed ejection steer pin (34) slidingly and traversing arranged in a matching throughbore (318) comprised in the cap gripper holder. Preferably, a plurality of ejection steer pins (34a-i), are arranged each respectively in a matching throughbore (318a-i) comprised in a third set of throughbores (318a-i) traverse arranged in the cap gripper holder (31).

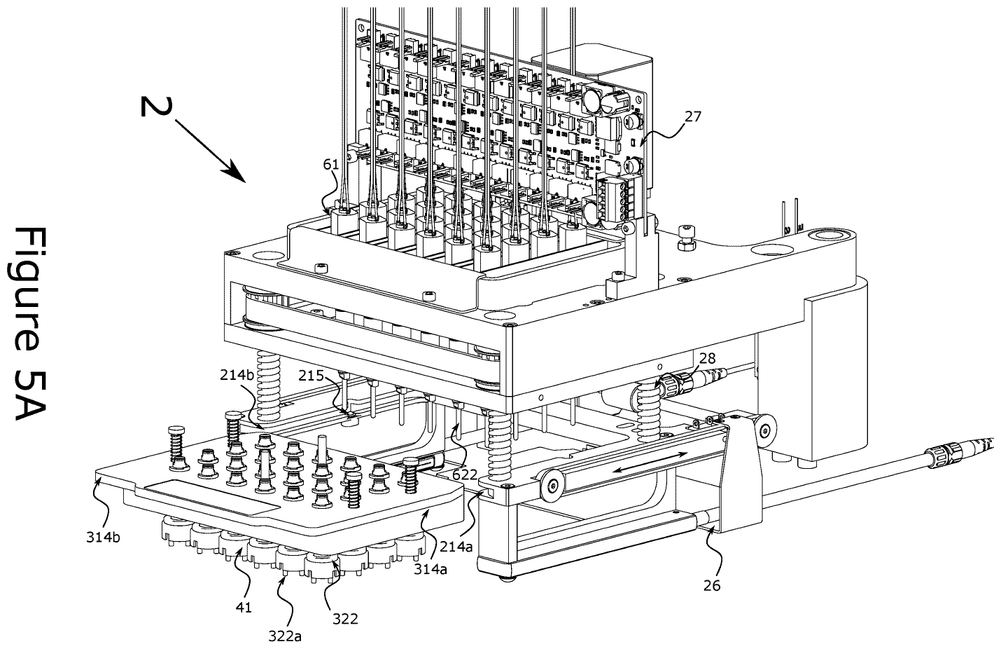

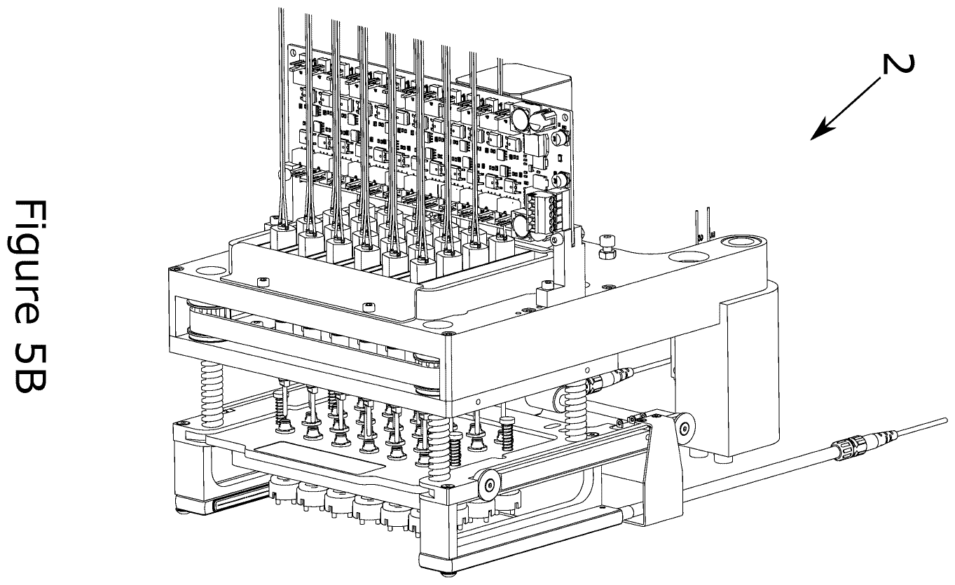

In an embodiment according to any embodiment of the present disclosure (c.f. FIGS. 2 and 5A), there is herein disclosed a cap gripper cartridge (3), wherein the cap gripper holder (31) comprises at least two respective cap gripper holder positioning elements (314a,314b) adapted for being received and held in a fixed use position during a capping and de-capping operation by respective and opposing cartridge positioning elements (214a,214b) comprised in the head unit (2).

In an embodiment thereof, there is disclosed a cap gripper cartridge (3), wherein either the cap gripper holder positioning elements (314a,314b) or the opposing cartridge positioning elements (214a,214b) comprise at least two respective flanges (314a,314b) adapted for being received in at least two respective opposing grooves (214a,214b) being comprised in the remaining and opposing positioning elements (314a,314b,214a,214b) of the cap gripper holder (31) or the head unit (2).

In an embodiment thereof, there is disclosed a cap gripper cartridge (3), wherein the cap gripper holder (31) is held in a fixed use position in the head unit (2) during a capping and de-capping operation using at least one fixture means (215,315a,315b).

In an embodiment thereof, there is disclosed a cap gripper cartridge (3), wherein the at least one fixture means (215,315a,315b) comprises a ball-lock fixture (215,315a,315b), wherein at least one of either the cap gripper holder positioning elements (314a,314b) or the opposing cartridge positioning elements (214a,214b) carries a ball-part (215) of a ball-lock fixture while a remaining and opposing positioning element (314a,314b,214a,214b) carries a receptacle (315a,315b) for a ball-part of a ball-lock fixture.

In an embodiment thereof, there is disclosed a cap gripper cartridge (3), wherein a the cap socket (41) is arranged for receiving and holding a test tube screw cap (51) in a cap socket interior (411).

In an embodiment thereof, there is disclosed a cap gripper cartridge (3), wherein the cap ejector plate (32) comprises for each respective cap socket (41) at least one respective ejector tap (322a-d), and each respective cap socket (41) comprises for each respective ejector tap (322a-d) a respective ejector tap opening (412a-d) arranged for permitting a the respective ejector tap (312a-d) to engage and eject a test tube screw cap (51) held by the cap socket, when the cap ejector plate (32) is displaced relative away from the cap gripper holder (31).

In an embodiment thereof, there is disclosed a cap gripper cartridge (3), wherein the at least one respective ejector tap (322a-d) is comprised on a tap carrier (322) slidingly arranged between the cap ejector plate (32) and the cap socket (41) around the cap gripper axle (42).

In an embodiment thereof, there is disclosed a cap gripper cartridge (3), wherein the cap ejector plate (32) comprises for each respective cap socket (41), at least two, at least three, but preferably four, respective ejector taps (322a-d).

In an embodiment of the cap gripper cartridge (3), there is disclosed a cap gripper cartridge (3), wherein each respective cap gripper (4) is individually actuated by a respective actuator unit (6) held in the head unit (2).

As discussed above, the use of an ejector plate (31) for ejecting caps held in cap sockets in the cartridges of the present invention (3) rather than internal and individual ejection means such as the ejector pins of the prior art, permits the use of a transmission system (7) in the cartridges (3) of the present disclosure, thereby obtaining increased versatility in the construction of the head unit (2).

In accordance therefore with a preferred embodiment of the present invention there is herein detailed a cap gripper cartridge (3) according to any of the previous embodiments, wherein the cap gripper cartridge (3) comprises a transmission system (7) for allowing a number of actuators (6) comprised in the head unit (2), the number of actuators (6) being different from, but preferably smaller than, the number of cap grippers (4) comprised in the two-dimensional array (313), to actuate a capping or a de-capping operation of all cap grippers (4) comprised in the two-dimensional array of the cap gripper cartridge (3).

While the skilled person will now of many ways to construct suitable transmission systems (7) suitable for use in the present cap gripper cartridges (3) for obtaining the abovementioned benefits, below simple (and therefore preferred) transmission systems are detailed, which can easily be implemented into the cap gripper cartridges (3) of the present invention.

In an exemplary transmission system (7) (c.f. FIGS. 6, 7 and 8) and embodiments thereof, in the transmission system (7), each respective head unit connector (43) comprised in the cap gripper cartridge (3) comprises a respective cogwheel (43a-d) presenting teeth perpendicular to the common axis of engagement (22) and not having a diameter of rotation overlapping with another respective cogwheel of another respective head unit connector (43) in the cap gripper cartridge (3).

In an embodiment thereof, in the transmission system (7), each respective head unit connector (43) is rotably held by in respective throughbores of a holder plate (71) arranged in parallel to the cap gripper holder (31) opposite to the ejector plate (32) with respect to the cap gripper holder (31).

In an embodiment thereof, in the transmission system (7), a transmission cogwheel (72) is arranged for rotably engaging a group of at least two respective cogwheels (43a-d) of at least two respective head unit connectors (43), the transmission cogwheel (72) further comprising means for connecting to a cap driver connector unit (63) of an actuator unit (6) comprised in the head unit (2), such that a rotation actuated by the actuator unit (6) is transferred to a rotation of each respective cogwheel (43a-d) of the group of the at least two respective cogwheels via the transmission cogwheel (72).

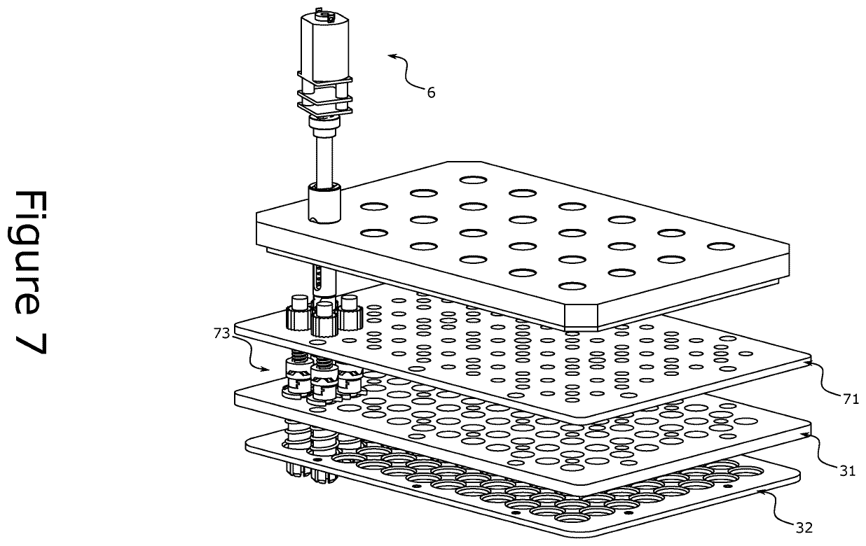

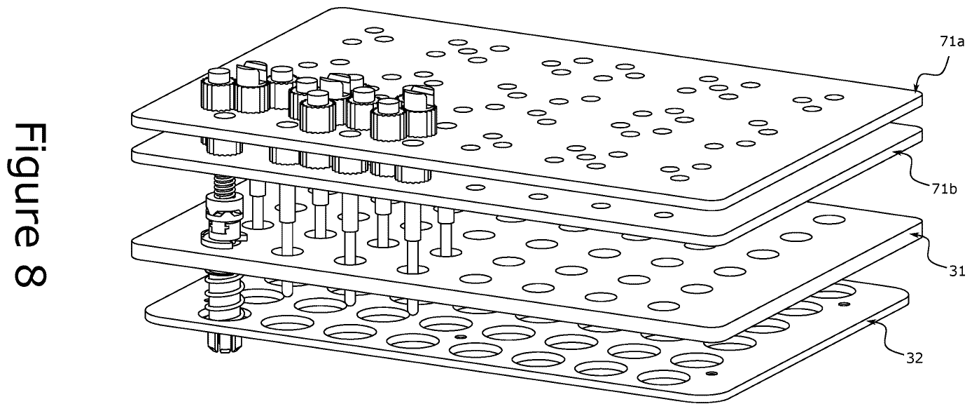

In an embodiment thereof, the group of at least two respective cogwheels (43a-d) is a group of either two or four, preferably four, cogwheels (43a-d). As shown in in FIGS. 7 and 8, groups of four cogwheels (43a-d) can increase (or reduce if operated in reverse) a 4×6 actuator unit (6) head unit to be used with a 8×12 test tube rack.

In the embodiment shown in FIG. 8, a double layered transmission system of cogwheels is employed, which is suitable for use with a 24 actuator units head unit, but where the test tube rack holds 48 test tubes. Here, a first layer (71a) having a group of four cogwheels forms an intermediate layer, wherein each group of four cogwheels drives a single connector cogwheel, which interacts with a group of two cogwheels in a second (lower) layer (71b), each of these cogwheels of the groups of two cogwheels being a head unit connector (43) for a cap gripper (4) held by the aforementioned cap gripper holder (31).

A problem in using a transmission system (7) of cogwheels detailed herein is, that the torque experiences by the individual screw caps when applying them to the test tubes can no longer be measured in the actuator unit as done in the prior art. To overcome this problem (c.f. FIG. 6) is it preferable to arrange on each respective cap gripper axle (42) a jaw clutch (73) having a predetermined sliding torque arranged between the holder plate (71) and the cap gripper holder (31). Thereby, when the sliding torque is exceeded, the jaw clutch sliding prevents further tightening of the screw caps to the test tubes, thereby preventing damage to the parts.

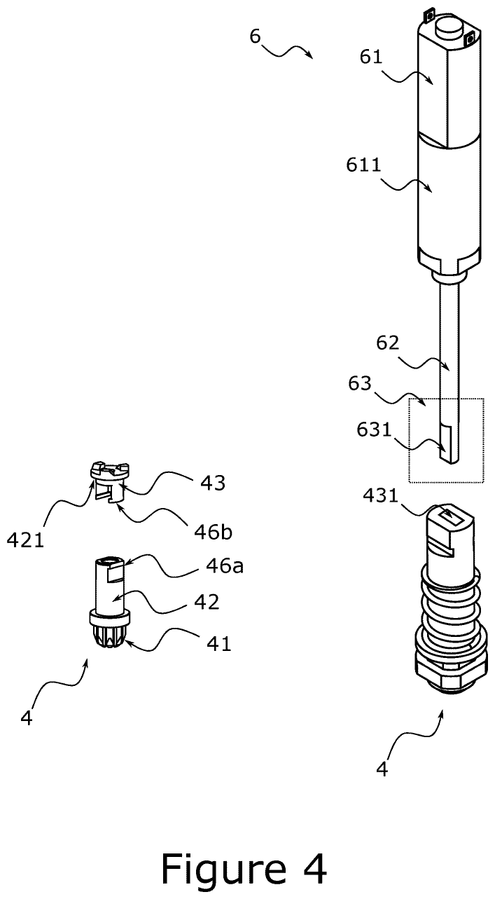

For use with head units (2) of the present invention, in one embodiment as detailed in FIG. 4, a respective actuator unit (6) comprises an actuator (61) comprising an electromotor (611) and a drive shaft (62) for connecting to the cap gripper (4) forming a rotation assembly, for transferring a rotation of the electromotor (611) into a rotation of the cap gripper (4), for permitting a screw cap capping or de-capping operation to be performed when a head unit (2) comprising the actuator unit (61) is moved either towards or away the test tube as required by the desired capping or de-capping operation.

For use with head units (2) of the present invention, in one embodiment as detailed in FIG. 4, the drive shaft (62) presents a cap driver connector unit (63), which is arranged for connecting to the head unit connector (43) and, when connected, permitting the transfer of the rotation of the electromotor (611) into a rotation of the cap gripper (4), whereby a screw cap capping or de-capping operation can be performed when a head unit (2) comprising the actuator unit (61) and holding a screw cap (51) on the cap gripper (4) is moved either towards or away the test tube as required by the desired capping or de-capping operation.

For use with head units (2) of the present invention, in one embodiment the cap driver connector unit (63) is in the form of a connector tap (631), arranged for engaging an aligned complementary receptacle (431), here in the form of an aligned tap receptable (431), comprised in the head unit connector (43), whereby after connection of the cap driver connector unit (63) to the head unit connector (43), here in the form of insertion of the connector tap (631) into the tap receptable (431), a rotation of the drive shaft (62) caused by the actuator unit (6) can be transferred to a desired rotation of the cap driver (4). By the connection of the actuator unit (6) and the cap driver (4) a cap driver rotation assembly is formed. The drive shaft (62) shown in FIG. 4 is exaggerated in length comparative to the cap driver for explanatory purposes. Normally, to avoid rotational vibration, it is kept as short as geometrically possible in a given head unit (2).

In FIG. 4, the connector tap (631) and the aligned tap receptable (431) are shown as rectangular, but other geometric shapes are equally useful as taps and aligned receptable, as is well known to the skilled person. Reversely, but not shown, the tap (631) can be comprised on the cap driver's (4) head unit connector (43) and the tap receptacle (431) can be held at the end of the drive shaft (62). But normally, the driveshaft (62) will carry the tap (631) as this is the easiest embodiment to manufacture and assemble, and the present invention is discussed based on this embodiment.

For mounting the cap gripper cartridge (3) of the present disclosure into the head unit (2), the cap gripper cartridge (3) is firstly inserted into its use position in the head unit (2), eventually also secured into the same use position using the fixture means (215) for holding the cap gripper cartridge (3) in a fixed use position during a capping and de-capping operation, and the cap gripper cartridge (3) and head unit (2) are subsequently brought together, for permitting the cap driver connector unit (63) and the head unit connector (43) to connect and, when connected, permitting the transfer of a rotation of the electromotor (611) into a rotation of the cap gripper (4). In the shown example, the respective taps (621) comprised on the respective drive shafts (62), are inserted into respective aligned tap receptacles (441) on respective cap drivers (4) held in the cap gripper cartridge (3).

In an embodiment thereof (c.f. FIGS. 3 and 5), there is disclosed a cap gripper cartridge (3), wherein each respective cap gripper (4) comprises a respective steering pin receptacle (44), preferably a respective steering pin throughbore (44), concentrically arranged within a respective cap gripper axle (42) for receiving a respective steering pin (622) held by the head unit (2), a respective steering pin (622) displaceable within a respective steering pin receptacle (44) during a displacement of the cap ejector plate (32) for ejecting a test tube screw cap (51), but without engaging the same test tube screw cap (51) held by the cap socket (41).

In an embodiment thereof, there is disclosed a cap gripper cartridge (3), wherein each respective actuator unit (6) held in the head unit (2) rotably holds a respective steering pin (62).

In the cap gripper cartridges (3) of the present disclosure (c.f. FIG. 2), it is in many situations in use advantageous if, in the cap gripper cartridge (3) of the invention, the cap gripper holder (31) comprises a skirt (316) enclosing the cap ejector plate (32), when assembled with the plurality of respective throughbores (321) around respective cap gripper axles. The presence of a skirt (316) on the cap gripper holder (31) enclosing the assembled cap ejector plate (32) provides in one embodiment means for protecting the assembled cap grippers from unwanted or accidental user contact during exchange of the cartridge; and in another embodiment it provides a fixture for adapting the cap ejector plate (32) and the skirt (316) with complementary steers, such that wobbling or like movement of the test tubes or cartridge during de-capping does not result in misalignment of ejector plate (32) and screw caps (51) prior to recapping and subsequent ejection. As an example of complementary steers (not shown), one of either the skirt (316) or the ejector plate (32) may comprise one or more respective slits for guiding a complementarily arranged respective flange on the remaining of either the skirt (316) or the ejector plate (32).

As mentioned, however, it is a particularly beneficial aspect of the present invention that it is possible to equip the cartridges of the present invention with a transmission system (7) or parts thereof, such that the number can be reduced of actuators comprised in the head unit (2) that are needed for rotating the cap drivers (4) held by the present cartridges (3) during a capping- or de-capping operation.

In a second aspect of the present invention (c.f. FIGS. 5A and 5B), there is herein disclosed a head unit (2) for a test tube capper-decapper device (1), the head unit adapted for receiving a cap gripper cartridge (3) according to any of the preceding embodiments and comprising at least two cartridge positioning elements (214a,214b) opposing at least two respective cap gripper holder positioning elements (314a,314b), whereby the cap gripper cartridge (3) can be received and held in a fixed use position during a capping and de-capping operation by respective and opposing cartridge positioning elements (214a-b,314a-b).

In an embodiment thereof, there is herein disclosed a head unit (2) for a test tube capper-decapper device (1), comprising further fixture means (215) for holding the cap gripper cartridge (3) in a fixed use position during a capping and de-capping operation.

In an embodiment thereof, there is herein disclosed a head unit (2) for a test tube capper-decapper device (1), further comprising a plurality of steering pins (622) arranged in number and position to match respective steering pin receptacles concentrically arranged within respective cap gripper axles (42) in the two-dimensional array (313) of cap grippers (4).

In an embodiment thereof, there is herein disclosed a head unit (2) for a test tube capper-decapper device (1), further comprising a drip tray (26) arranged for being positioned beneath the cap gripper cartridge (3) when loaded into the head unit (2) for preventing residual liquid held in respective test tube screw caps (51) detached from respective test tubes (5) from dripping onto a surface below the cap gripper cartridge (3).

In an embodiment thereof, there is herein disclosed a head unit (2) for a test tube capper-decapper device (1), further comprising control logics (27).

In an embodiment thereof, there is herein disclosed a head unit (2) for a test tube capper-decapper device (1), further comprising at least one engagement surface (not shown, hidden in FIGS. 5A and 5B) matching in number and position the at least one ejector plate displacer (33), such that the ejector plate displacer (33) can be actuated by actuation means (not shown) comprised in the head unit (2) for ejecting a test tube screw cap (51) held by a cap socket (41) comprised in the cap driver cartridge (3).

In the present capper-decapper device (1) movement of the head unit (2) relatively towards and away from cap gripper cartridge (3) prior to assembly of the cartridge (3) into the head unit (2) is done by means of a spindle (28). To ascertain that the cartridge (3) can be disassembled from the head unit (2), the head unit (2) should have a travel distance which is not shared with the cartridge (3). The introduction of a limitation on the height the spindle-mechanism (28) will permit the cap gripper cartridge (3) to travel relatively away from a test tube (5) held in a test tube rack under the head unit (2), and not having the same limitation on the head unit (2) itself, is therefore beneficial.

It is beneficial, that in an embodiment, the head unit (2) comprises disengagement means for permitting the head unit (2) be moved reversibly to or from a position wherein the respective cap driver connector units (63) of the head unit (2) engage the respective head unit connectors (43) of the cap drivers (4) held in the cap gripper cartridge (3) for allowing insertion or removal of the cap gripper cartridge (3) from the head unit (2).

In a third aspect, there is herein disclosed a screw cap test tube capper-decapper device (1) comprising a head unit (2) according to any of the embodiments detailed herein.

In an embodiment thereof, the screw cap test tube capper-decapper device (1) further comprises a cap gripper cartridge (3) according to any embodiment disclosed herein, preferably, wherein a cap gripper cartridge (3) according to any embodiment disclosed herein has been mounted in the head unit (2) as a cartridge-head unit-assembly.

### Closing Comments

Although the present invention has been described in detail for purpose of illustration, it is understood that such detail is solely for that purpose, and variations can be made therein by those skilled in the art in practicing the claimed subject matter, from a study of the drawings, the disclosure, and the appended claims.

The term “comprising” as used in the claims does not exclude other elements or steps. The indefinite article “a” or “an” as used in the claims does not exclude a plurality. A single processor or other unit may fulfill the functions of several means recited in the claims. A reference sign used in a claim shall not be construed as limiting the scope.

1. A cap gripper cartridge for releasably connecting to a head unit of a screw cap test tube capper-decapper device and having a common axis of engagement after connecting, said cap gripper cartridge comprising:
a cap gripper holder defining a head unit side and a test tube side and rotatably bearing a plurality of cap grippers arranged in a two-dimensional array, said common axis of engagement being perpendicular to said two-dimensional array, wherein
a respective cap gripper comprises a respective cap socket arranged for engaging and retaining a test tube screw cap during and after a capping or a de-capping of said test tube screw cap to or from a screw cap test tube,
a respective cap socket is connected by a respective cap gripper axle arranged in parallel to said common axis of engagement, to a respective head unit connector, said respective head unit connector arranged for connecting to said head unit, and transferring after connection a rotation received from said head unit to a rotation of said respective cap socket, and wherein
each respective cap socket presents to said test tube side, and each respective head unit connector presents to said head unit side;
said cap gripper cartridge further comprising:
a cap ejector plate comprising a plurality of respective throughbores, a respective throughbore arranged around a respective cap gripper axle of a respective cap gripper comprised in said two-dimensional array, between said cap gripper holder and said respective cap socket; and
at least one actuable cap ejector plate displacer;
wherein
said cap ejector plate is arranged for being displaced by said actuable cap ejector plate displacer along said common axis of engagement relative away from said cap gripper holder for engaging all respective test tube screw caps retained in all respective cap sockets comprised in all respective cap grippers held by said cap gripper cartridge, and effecting by said displacement a release of said all retained test tube screw caps from all respective cap sockets holding a screw cap.

2. A cap gripper cartridge according to claim 1 comprising at least two actuatable cap ejector plate displacers.

3. A cap gripper cartridge according to claim 1, wherein a said actuatable ejector plate displacer is biased for restricting said displacement of said cap ejector plate to a reversible displacement between a first position not engaging a respective test tube screw cap retained by a respective cap socket and a second position ejecting said respective test tube screw cap from said respective cap socket.

4. A cap gripper cartridge according to claim 1, wherein said cap gripper holder comprises at least two respective cap gripper holder positioning elements adapted for being received and held in a fixed use position during a capping and de-capping operation by respective and opposing cartridge positioning elements comprised in said head unit.

5. A cap gripper cartridge according to claim 4, wherein either said cap gripper holder positioning elements or said opposing cartridge positioning elements comprises at least two respective flanges adapted for being received in at least two respective opposing grooves being comprised in the remaining and opposing positioning elements of said cap gripper holder or said head unit.

6. A cap gripper cartridge according to claim 4, wherein said cap gripper holder is arranged for being held in a fixed use position in said head unit during a capping and de-capping operation using at least one fixture means.

7. A cap gripper cartridge according to claim 6, wherein said at least one fixture means comprises a ball-lock fixture, wherein at least one of either said cap gripper holder positioning elements or said opposing cartridge positioning elements carries a ball-part of a ball-lock fixture while a remaining and opposing positioning element carries a receptacle for a ball-part of a ball-lock fixture.

8. A cap gripper cartridge according to claim 1, wherein a said cap socket is arranged for receiving and holding a test tube screw cap in a cap socket interior.

9. A cap gripper cartridge according to claim 1, wherein said cap ejector plate comprises for each respective cap socket at least one respective ejector tap, and each respective cap socket comprises for each respective ejector tap a respective ejector tap opening arranged for permitting a said respective ejector tap to engage and eject a test tube screw cap held by said cap socket, when said cap ejector plate is displaced relative away from said cap gripper holder.

10. A cap gripper cartridge according to claim 9, wherein said at least one respective ejector tap is comprised on a tap carrier slidingly arranged between said cap ejector plate and a said cap socket around a said cap gripper axle.

11. A cap gripper cartridge according to claim 9, wherein said cap ejector plate comprises for each respective cap socket at least two respective ejector taps.

12. A cap gripper cartridge according to claim 1, wherein each respective cap gripper comprises a respective steering pin receptacle, concentrically arranged within a respective cap gripper axle for receiving a respective steering pin held by said head unit, a respective steering pin displaceable within a respective steering pin receptacle during said displacement of said cap ejector plate without engaging a test tube screw cap held by a cap socket.

13. A cap gripper cartridge according to claim 1, wherein rotation of each respective cap gripper is individually actuated by a respective actuator unit held in said head unit, each respective actuator unit comprising a cap driver connector unit for connecting to a paired respective head unit connector of said respective cap gripper, and a steering pin.

14. A cap gripper cartridge according to claim 1, wherein said cap gripper cartridge comprises a transmission system for allowing a number of actuators comprised in said head unit, said number of actuators being different from the number of cap grippers comprised in said two-dimensional array, to actuate a capping or a de-capping operation of all cap grippers comprised in said two-dimensional array of said cap gripper cartridge.

15. A cap gripper cartridge according to claim 14, where, in said transmission system, each respective head unit connector comprised in said cap gripper cartridge comprises a respective cogwheel presenting teeth perpendicular to said common axis of engagement and not having a diameter of rotation overlapping with another respective cogwheel of another respective head unit connector in said cap gripper cartridge.

16. A cap gripper cartridge according to claim 15, where, in said transmission system, each respective head unit connector is rotably held by in respective throughbores of a holder plate arranged in parallel to said cap gripper holder opposite to said ejector plate with respect to said cap gripper holder.

17. A cap gripper cartridge according to claim 15, where, in said transmission system, a transmission cogwheel is arranged for rotably engaging a group of at least two respective cogwheels of at least two respective head unit connectors, said transmission cogwheel further comprising means for connecting to a cap driver connector unit of an actuator unit comprised in said head unit, such that a rotation actuated by said actuator unit is transferred to a rotation of each respective cogwheel of said group of said at least two respective cogwheels via said transmission cogwheel.

18. A cap gripper cartridge according to claim 17, where said group of at least two respective cogwheels is a group of either two or four cogwheels.

19. A cap gripper cartridge according to claim 16, where, in said transmission system, each respective cap gripper axle comprises a jaw clutch having a predetermined sliding torque arranged between said holder plate and said cap gripper holder.

20. A head unit for a test tube capper-decapper device, the head unit adapted for receiving a cap gripper cartridge according to claim 1, and comprising at least two cartridge positioning elements opposing at least two respective cap gripper holder positioning elements on said cap gripper holder, whereby said cap gripper cartridge can be received and held in a fixed use position during a capping and de-capping operation by respective and opposing positioning elements.

21. A head unit for a test tube capper-decapper device according to claim 20, further comprising fixture means for holding said cap gripper cartridge in a fixed use position during a capping and de-capping operation.

22. A head unit for a test tube capper-decapper device according to claim 20, further comprising a plurality of steering pins arranged in number and position to match respective steering pin receptacles concentrically arranged within respective cap gripper axles in said two-dimensional array of cap grippers.

23. A head unit for a test tube capper-decapper device according to claim 20, further comprising a drip tray arranged for being positioned beneath said cap gripper cartridge when loaded into said head unit for preventing residual liquid held in respective test tube screw caps detached from respective test tubes from dripping onto a surface below said cap gripper cartridge.

24. A head unit for a test tube capper-decapper device according to claim 20, further comprising control logics.

25. A head unit for a test tube capper-decapper device according to claim 20, further comprising at least one engagement surface matching in number and position said at least one ejector plate displacer, such that said ejector plate displacer can be actuated by actuation means comprised in said head unit for ejecting a test tube screw cap held by a cap socket comprised in said cap driver cartridge.

26. A screw cap test tube capper-decapper device comprising a head unit according to claim 20.

27. A screw cap test tube capper-decapper device according to claim 26 and further comprising a cap gripper cartridge for releasably connecting to a head unit of a screw cap test tube capper-decapper device and having a common axis of engagement after connecting, said cap gripper cartridge comprising:
a cap gripper holder defining a head unit side and a test tube side and rotatably bearing a plurality of cap grippers arranged in a two-dimensional array, said common axis of engagement being perpendicular to said two-dimensional array, wherein
a respective cap gripper comprises a respective cap socket arranged for engaging and retaining a test tube screw cap during and after a capping or a de-capping of said test tube screw cap to or from a screw cap test tube,
a respective cap socket is connected by a respective cap gripper axle arranged in parallel to said common axis of engagement, to a respective head unit connector, said respective head unit connector arranged for connecting to said head unit, and transferring after connection a rotation received from said head unit to a rotation of said respective cap socket, and wherein
each respective cap socket presents to said test tube side, and each respective head unit connector presents to said head unit side;
said cap gripper cartridge further comprising:
a cap ejector plate comprising a plurality of respective throughbores, a respective throughbore arranged around a respective cap gripper axle of a respective cap gripper comprised in said two-dimensional array, between said cap gripper holder and said respective cap socket; and
at least one actuable cap ejector plate displacer;
wherein
said cap ejector plate is arranged for being displaced by said actuable cap ejector plate displacer along said common axis of engagement relative away from said cap gripper holder for engaging all respective test tube screw caps retained in all respective cap sockets comprised in all respective cap grippers held by said cap gripper cartridge, and effecting by said displacement a release of said all retained test tube screw caps from all respective cap sockets holding a screw cap.
